(19) United States
(12) Patent Application Publication
(10) Pub. No.: US 2004/0190878 A1
(43) Pub. Date: Sep. 30, 2004

(54) Video data conversion apparatus and video data conversion

(75) Inventor: Manabu Shibutani, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/724,578

(22) Filed: Nov. 28, 2003

(30) Foreign Application Priority Data
Nov. 29, 2002 (JP) 2002-347502

(51) Int. Cl. H04N 5/781

(52) U.S. Cl. 386/125; 386/126

(57) ABSTRACT

A conversion unit is configured to convert first video data which complies with a MPEG standard and has a plurality of different aspect ratios defined therein into second video data which complies with the same MPEG standard and has a single aspect ratio defined therein. The conversion takes place by directly writing data corresponding to the plurality of aspect ratios within the first video data as a single aspect ratio to form said second video data. The conversion takes place without first converting the first video data into analog data.

### CROSS-REFERENCE TO RELATED APPLICATIONS

This application is based upon and claims the benefit of priority from the prior Japanese Patent Application No. 2002-347502, filed Nov. 29, 2002, the entire contents of which are incorporated herein by reference.

### BACKGROUND OF THE INVENTION

1. Field of the Invention

The present invention relates to a video data conversion apparatus and video data conversion method for converting video data complying with MPEG.

2. Description of the Related Art

A DVD-Video Recording standard (to be referred to as a DVD-VR standard hereinafter) is known as a format for recording video data on an optical disk or magnetic disk in real time. The DVD-VR standard adopts a format that complies with MPEG (Moving Picture Expert Group) as the international standard, which specifies the video data encoding format, and allows easy real-time video recording, and playback, editing, and the like of recorded data.

On the other hand, DVD-Video media, which store video products such as movies and the like as read-only media adopt a DVD-Video standard as its recording format. Like the DVD-VR standard, the DVD-Video standard also complies with MPEG2, but has no structure to allow for easy editing because it is a recording format for read-only media. That is, these two standards are not necessarily the same even though they both comply with MPEG.

For example, these two standards have different aspect ratio setups. Whereas the DVD-VR standard can set different aspect ratios for relatively small data units, the DVD-Video standard does not permit such different aspect ratio setups.

In general, 4:3 and 16:9 are the available aspect ratios for a digital video signal. For example, an up conversion technique for converting a digital video signal from a current format (i.e., CCIR 601 525 format, aspect ratio=4:3, 720×486 pixels) to a high-definition format (i.e., SMPTE 240M format, aspect ratio=16:9, 1,920×1,035 pixels) has been disclosed (Jpn. Pat. Appln. KOKAI Publication No. 5-137124).

Since the DVD-VR and DVD-Video standards have a difference associated with their respective aspect ratio setups, a problem is posed upon converting data from the DVD-VR standard into the DVD-Video standard. The conversion technique disclosed in the aforementioned reference, however, does not contemplate data conversion from the DVD-VR standard into the DVD-Video standard. As a result, it cannot solve the problem arising from the differences in the aspect ratio setups.

Despite this problem, the attributes of the two standards make desirable the data conversion from the DVD-VR standard into the DVD-Video standard. In recent years, DVD-R disks, which are of write once type and are physically compatible to DVD-Video disks, have dominated the market. When data is written on a DVD-R disk using the DVD-Video standard format, the DVD-R disk can be played back in an environment that allows playback of that DVD-Video. Video data is commonly recorded in the DVD-VR standard format because it is suited to real-time recording and provides for an editing process. After recording in the DVD-VR standard, however, the processed video data is written on a DVD-R disk in the DVD-Video standard format, which requires data conversion from the DVD-VR standard to the DVD-Video standard.

To accomplish such a data conversion, a known conversion method decodes data complying with the DVD-VR standard into an analog signal, plays back the decoded analog signal, encodes the played-back data into data complying with the DVD-Video standard, and records the encoded data on a DVD-R disk. However, with this method, encoding video and audio data from an analog signal into the DVD-Video format after first decoding the original digital video data in the DVD-VR format degrades the video data in the DVD-Video format as compared to the original video data in the DVD-VR format.

### BRIEF SUMMARY OF THE INVENTION

In accordance with embodiments of the invention a video data conversion apparatus is described in which a conversion unit is configured to convert first video data which complies with a MPEG standard and has a plurality of different aspect ratios defined therein into second video data which complies with the same MPEG standard and has a single aspect ratio defined therein. The conversion is performed by directly writing data corresponding to said plurality of aspect ratios within said first video data as a single aspect ratio to form the second video data. Moreover, the conversion is performed without first converting said first video data into analog data.

Embodiments of the invention are also directed to a method of video data conversion which involves converting first video data which complies with a MPEG standard and has a plurality of different aspect ratios defined therein into second video data which complies with the MPEG standard and has a single aspect ratio defined. The conversion method involves directly writing data corresponding to the plurality of aspect ratios within said first video data as a single aspect ratio to form the second video data. Moreover, the conversion takes place without first converting the first video data into analog data.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below serve to explain the principles of the invention.

FIG. 1 shows an example of the data structure of DVD-VR data complying with the DVD-VR standard;

FIG. 2 shows an example of the data structure of a VOBU in the DVD-VR standard;

FIG. 3 shows an example of the data structure of a VOBU in the DVD-Video standard;

FIG. 4 shows an example of the data structure of a sequence header which contains information associated with aspect ratios in display data;

FIG. 5 shows an example of the data structure of a sequence display extension which contains information associated with aspect ratios in display data;

FIG. 6 shows an example of the data structure of DVD-Video data complying with the DVD-Video standard;

FIG. 7 is a block diagram showing an example of the arrangement of an optical disk recording/ playback/edit apparatus which can implement a format conversion process and editing process;

FIG. 8 is a flowchart for explaining an example of a pre-process used to convert data complying with the DVD-VR standard into that complying with the DVD-Video standard;

FIG. 9 is a flowchart for explaining an example of a conversion process for converting data complying with the DVD-VR standard into that complying with the DVD-Video standard;

FIG. 10 is a flowchart for explaining an example of a VOBS conversion process for converting a VOBS complying with the DVD-VR standard into that complying with the DVD-Video standard;

FIG. 11 is a flowchart showing an example of conversion associated with aspect ratio in a VOBU conversion process; and

FIG. 12 is a flowchart for explaining an example of a process for converting recorded video data into data with an appropriate aspect ratio when broadcast contents in which an aspect ratio is switched in the middle are recorded.

### DETAILED DESCRIPTION OF THE PREFERRED EMBODIMENTS

Preferred embodiments of the present invention will be described hereinafter with reference to the accompanying drawings.

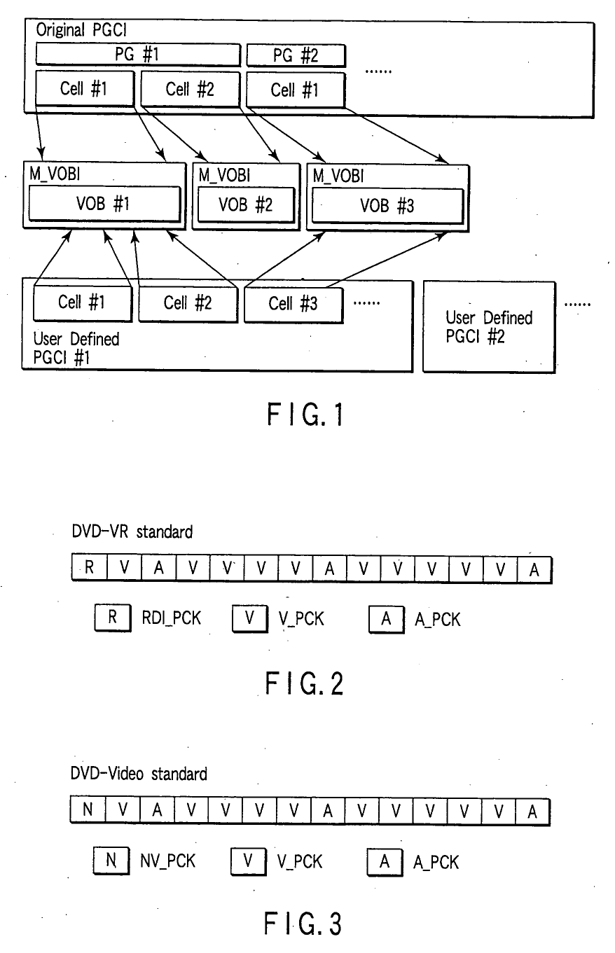

The data structure of DVD-VR data complying with the DVD-VR standard, and aspect ratio information in that structure will be explained first. FIG. 1 shows the data structure of DVD-VR data complying with the DVD-VR standard. As shown in FIG. 1, DVD-VR data complying with the DVD-VR standard contains a plurality of VOBs (Video Objects) formed by encoding audio and video data, and a plurality of pieces of M_VOBI (Movie AV File Information) which correspond to respective VOBs and are used to manage these VOBs. Put differently, DVD-VR data complying with the DVD-VR standard contains one original PGC (Program Chain) and a plurality of user defined PGCs. The original PGC contains recorded display data and its management information. Each user defined PGC consists of only management information, and refers to the display data contained in the original PGC.

The display data is made up of the plurality of VOBs (Video Objects) described above. Each VOB consists of a plurality of VOBUs (Video Object Units). Each VOBU is normally 0.5-sec long display data, and consists of RDI_PCK, V_PCKs, A_PCKs, and the like, as shown in FIG. 2. The RDI_PCK is present at the head of each VOBU, and describes information associated with that VOBU and the like.

Information associated with aspect ratios in the DVD-VR standard includes Aspect Ratio and Application Flag fields applicable to each M_VOB, and an Aspect Ratio field in the RDI_PCK of each VOBU. The Application Flag field indicates whether the aspect ratio in a VOB is a common one specified by the Aspect Ratio field applicable to the corresponding M_VOB or must be determined with reference to each RDI_PCK. The Aspect Ratio field in the RDI_PCK indicates an aspect Ratio in that VOBU. The aforementioned data structure of the DVD-VR data thus enables video data with different aspect ratios to be mixed in each VOB.

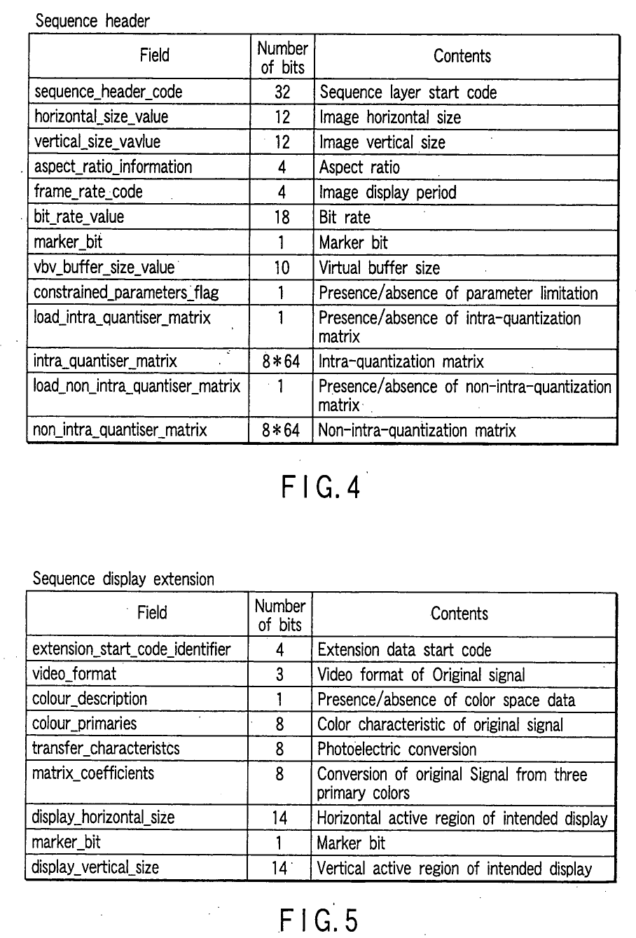

Information associated with aspect ratios in the display data, as shown in FIGS. 4 and 5, includes an Aspect Ratio Information field in a Sequence Header, and Display Horizontal Size and Display Vertical Size fields in a Sequence Display Extension. The Sequence Header is present in each VOBU. The Sequence Display Extension is information described after the Sequence Header, but is not always present.

The Aspect Ratio Information field describes an aspect ratio in the Sequence Header. The Display Horizontal Size and Display Vertical Size fields specify the horizontal and vertical sizes of an active area, which is determined by the vertical and horizontal sizes and the aspect ratio in the Sequence Header.

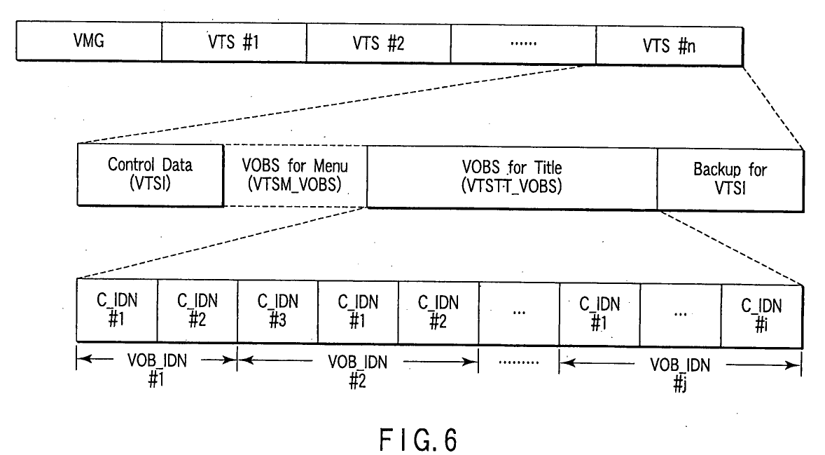

The data structure of DVD-Video data complying with the DVD-Video standard and Aspect Ratio Information in that structure will be described below. FIG. 6 shows the data structure of DVD-Video data complying with the DVD-Video standard. As shown in FIG. 6, DVD-Video data contains one VMG (Video Manager) and a plurality of VTSs (Video Title Sets).

The VMG contains management information and title menu information of the entire data structure. Each VTS consists of VTSI, VTSM_VOBS, VTSTT_VOBS, and VTSI_BUP. The VTSI is management information of a title set, the VTSM_VOBS is display information of a menu of the title set, VTSTT_VOBS is display information of the title set, and the VTSI_BUP is a backup of the VTSI.

Each VOBS (Video Object Set) contains display data and some pieces of management information, and consists of a plurality of VOBs (Video Objects). Each VOB is made up of a plurality of cells. Each cell consists of a plurality of VOBUs (Video Object Units). Each VOBU is normally 0.5-sec long display data, and consists of NV_PCK, V_PCKs, A_PCKs, SP_PCK, and the like, as shown in FIG. 3. The NV_PCK is always present at the head of each VOBU and describes information associated with that VOBU.

In the DVD-Video standard, information associated with an aspect ratio of video data is present in an Aspect Ratio field (VTS_A_ART), which describes an attribute of the video data in the management information of the VTSI, and specifies that the aspect ratio of an image in the corresponding VTS is 4:3 or 16:9. As can be seen from the aforementioned data structure of the DVD-Video data, it is not possible to mix video data with different aspect ratios in a VTS in the DVD-Video standard.

Information associated with aspect ratios in the display data, as shown in FIGS. 4 and 5, includes an Aspect Ratio Information field in a Sequence Header, and Display Horizontal Size and Display Vertical Size fields in a Sequence Display Extension, as in the DVD-VR standard

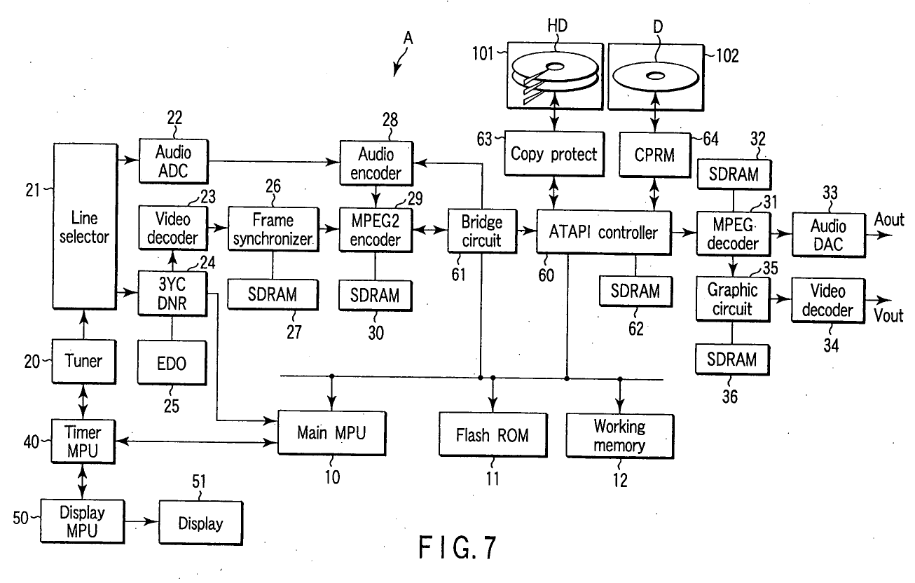

An example of the arrangement of an optical disk recording/playback/editing apparatus that can implement a format conversion process and editing process according to the present invention will be described below with reference to FIG. 7. An optical disk recording/playback/editing apparatus A shown in FIG. 7 comprises a main MPU 10, flash ROM 11, working memory 12, tuner 20, line selector 21, audio AD converter 22, video decoder 23, 3YCDNR 24, EDO 25, frame synchronizer 26, SDRAM 27, audio encoder 28, MPEG2 encoder 29, SDRAM 30, MPEG decoder 31, SDRAM 32, audio DA converter 33, video decoder 34, graphic circuit 35, SDRAM 36, timer MPU 40, display MPU 50, display 51, ATAPI controller 60, bridge circuit 61, SDRAM 62, copy protect 63, and CPRM 64.

The operation of the overall optical disk recording/playback apparatus A is controlled by the main MPU 10. The main MPU 10 is connected to the flash ROM 11 and working memory 12 via a data bus. An input terminal and the tuner 20 are connected to the line selector 21. The tuner 20 is connected to the timer MPU 40. The timer MPU 40 controls the operation of the tuner 20. The timer MPU 40 is also connected to the display MPU 50, which is connected to the display 51. The timer MPU 40 and display MPU 50 control the operation of the display 51.

A signal output from the line selector 21 is input to the audio AD converter 22 and 3YCDNR 24. An audio signal output from the audio AD converter 22 is input to the audio encoder 28. The audio encoder 28 encodes the input audio signal and outputs the encoded audio signal to the MPEG2 encoder 29. The SDRAM 30 is connected to the MPEG2 encoder 29. The EDO 25 is connected to the 3YCDNR 24. A signal output from the 3YCDNR 24 is input to the video decoder 23. A signal output from the video decoder 23 is input to the frame synchronizer 26. The SDRAM 27 is connected to the frame synchronizer 26. A frame signal output from the frame synchronizer 26 is input to the MPEG2 encoder 29.

The MPEG2 encoder 29 encodes an input signal. With this encoding, for example, MPEG stream data is generated. The MPEG stream data generated by the MPEG2 encoder 29 is output to the bridge circuit 61. The bridge circuit 61 outputs the input MPEG stream data to the ATAPI controller 60. The SDRAM 62 is connected to the ATAPI controller 60. The ATAPI controller 60 outputs the MPEG stream data to a disk drive 101 via the copy protect 63 or outputs that data to a disk drive 102 via the CPRM 64.

The disk drive 101 records MPEG stream data on a hard disk HD and reads MPEG stream data recorded on the hard disk HD. The disk drive 102 records MPEG stream data on an optical disk D and reads out MPEG stream data recorded on the optical disk D.

The MPEG stream data read from the disk is input to the MPEG decoder 31 via the ATAPI controller 60. The SDRAM 32 is connected to the MPEG decoder 31. The MPEG decoder 31 decodes the MPEG stream data, and outputs the decoded data to the audio DA converter 33 and graphic circuit 35. The audio DA converter 33 outputs an audio signal contained in the MPEG stream data. The SDRAM 36 is connected to the graphic circuit 35. A graphic signal output from the graphic circuit 35 is input to the video decoder 34. The video decoder 34 outputs a video signal.

An example of a conversion process of data recorded in the DVD-VR standard into data complying with the DVD-Video standard by changing its aspect ratios will be explained below. For example, a case will be described wherein the disk drive 101 reads data complying with the DVD-VR standard stored in the HDD, the read data is converted into data complying with the DVD-Video standard, and the disk drive 102 records the converted data on the optical disk D.

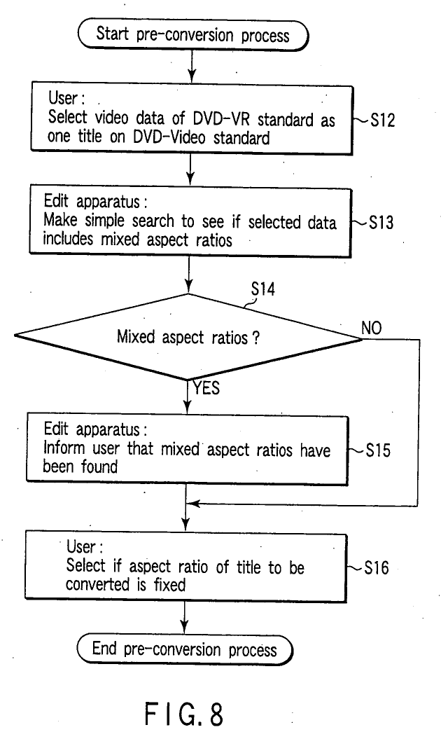

FIG. 8 is a flowchart showing an example of a pre-process before the conversion process starts. Note that the pre-process to be described below may be executed under the control of the main MPU 10 of the optical disk recording/playback/editing apparatus shown in FIG. 7. The user selects data on the DVD-VR standard stored in the hard disk HD as one title on the DVD-Video standard (S12). For example, an arbitrary VOB is selected. In this case, if the selected data on the DVD-VR standard has a plurality of aspect ratios (aspect ratio mismatch), the selected data cannot be converted into one title on the DVD-Video standard intact. Therefore, the selected data undergoes a simple check process (S13). If mixed aspect ratios are found (S14, YES), a message that calls the user's attention is displayed on the display 51 under the control of the display MPU 50 (S15). If no mixed aspect ratios are found (ST14, NO), no message is displayed.

The user selects if the aspect ratio of the selected data is that of original video data (no change in aspect ratio), is fixed to 4:3 (change in aspect ratio), or is fixed to 16:9 (change in aspect ratio) (S16). If the aspect ratio of the original video data is adopted, the same process as in the conventional method is done. If mixed aspect ratios are found during conversion, a process for aborting conversion or the like is required to prevent illegal data from being formed.

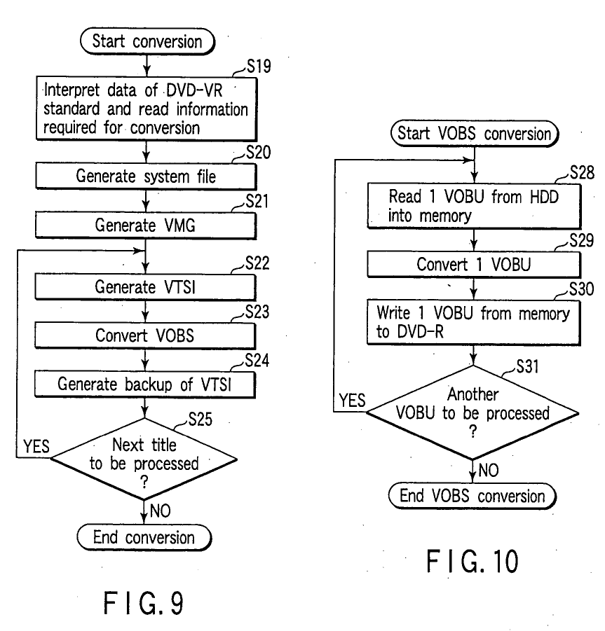

The following explanation will be given under the assumption that 4:3 fixed or 16:9 fixed is selected. An actual sequence for converting data of the DVD-VR standard into that of the DVD-Video standard will be described below with reference to the flowchart of FIG. 9. Note that the conversion process to be described below may be executed under the control of the main MPU 10 of the optical disk recording/playback/editing apparatus shown in FIG. 7. Also, data required for conversion, and various generated data are mapped onto a memory area of the working memory 12. That is, data required for conversion are read out onto the working memory 12, and are rewritten as needed to generate various data under the control of the main MPU 10.

Upon conversion from the DVD-VR standard into the DVD-Video standard, values required for conversion are loaded from management information and display data of the DVD-VR standard in the hard disk HD (S19). A DVD-Video file system and VMG are generated (S20, S21). VTSs are generated in correspondence with the number of titles (S22 to S25). Each VTS consists of VTSI, VOBSs, and a backup of VTSI.

Processes associated with an aspect ratio during the conversion are generation processes of VTSI and VOBSs. The Aspect Ratio field in V_ART in the VTSI describes an aspect ratio described in that title. VOBS conversion is accomplished by rewriting required values from the VOB of the DVD-VR standard. This process rewrites or changes values that are included in respective VOBUs and are associated with aspect ratios.

FIG. 10 is a flowchart showing a VOBS conversion sequence. A VOBU to be converted is read out from data in the DVD-VR standard in the hard disk HD, and is loaded onto the working memory 12 via the ATAPI controller 60 (S28). The main MPU 10 rewrites some values in the VOBU loaded in the working memory 12 to obtain data of the DVD-Video standard (S29). After that, the edited VOBU in the working memory 12 is output to the disk drive 102 via the ATAPI controller 60. That is, the edited VOBU is written to the optical disk D (S30). The aforementioned operations are repeated for all VOBUs to be converted (S31).

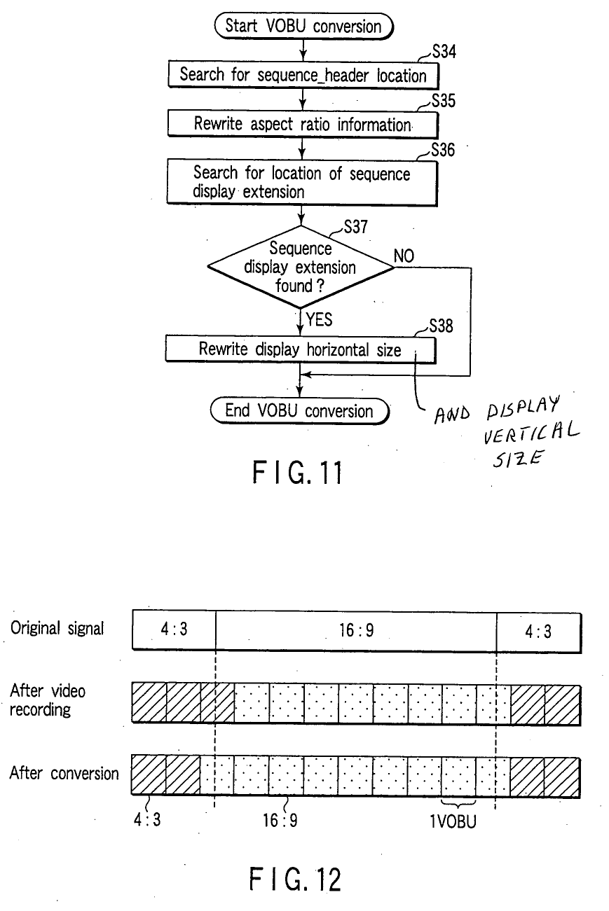

FIG. 11 is a flowchart showing conversion associated with aspect ratios in the VOBU conversion. An Aspect Ratio Information field in a Sequence Header can be rewritten first. In order to rewrite the aspect ratio information field, VOBU data stored in the working memory 12 is searched for a Sequence Start code (S34). If the Sequence Start code is found, the location of the Aspect Ratio Information field can be detected by its location relative to the Sequence Start code. A value suited to the aspect ratio of the user's choice is overwritten on the Aspect Ratio Information field (S35). If a Sequence Display Extension is present, a Display Horizontal Size field and a Display Vertical Size field in the Sequence Display Extension are also rewritten. The Sequence Display Extension is searched for to rewrite the Display Horizontal Size field and the Display Vertical Size field (S36). If no Sequence Display Extension is found, a rewrite process is skipped. If the Sequence Display Extension is found, the location of the Display Horizontal Size field and the Display Vertical Size field can be detected by their relative location from a value in that Sequence Display Extension. A value suited for an aspect ratio of the user's choice is overwritten on the Display Horizontal Size field and the Display Vertical Size field (S38). By repeating the aforementioned rewrite process for all VOBUs, the same aspect ratio can be set in all the VOBUs.

The operations and effects of the present invention will be summarized below. Upon converting video data recorded in the DVD-VR standard into data of the DVD-Video standard, if different aspect ratios are present in one title, that title cannot be converted due to limitations of the DVD-Video standard.

According to an aspect of the present invention, upon converting data of the DVD-VR standard into data of the DVD-Video standard, if one title includes different aspect ratios, that title is converted while fixing the aspect ratio in the title to a designated value. In the method of fixing the aspect ratio, upon converting data of the DVD-VR standard into that of the DVD-Video standard, the Aspect Ratio Information field in the Sequence Header of each VOBU is rewritten to a value that conforms to the designated aspect ratio. Furthermore, if a Sequence Display Extension is present, the Display Horizontal Size field and the Display Vertical Size field in that extension is rewritten to a value that conforms to the designated aspect ratio. In this manner, even data of the DVD-VR standard, which includes different aspect ratios in one title, can be converted into that of the DVD-Video standard without degrading the original video data.

With the aforementioned method, upon converting video data complying with a given MPEG standard into that complying with another MPEG standard, the aspect ratio can be converted at the same time. In the video data complying with the MPEG standard, some or all aspect ratios can be changed.

FIG. 12 shows an example upon recording a TV program in the DVD-VR standard. A case will be described below wherein an original signal shown in FIG. 12 is recorded. That is, the purpose of this recording process is to record a program with an aspect ratio=16:9, but assume that the recording process starts from a source with an aspect ratio=4:3 immediately before that program. In other words, the aspect ratio of the original signal is switched from 4:3 to 16:9 at a predetermined timing. For this reason, the switching position of the aspect ratio of the original signal does not often match that after recording. More specifically, upon encoding the original signal, even when the program of the aspect ratio=16:9 has started, if its start is in the middle of a VOBU, the program is recorded to have the aspect ratio=4:3, and the aspect ratio is switched to 16:9 from the next VOBU. Therefore, the head part of the program of the aspect ratio=16:9 may be recorded at 4:3. In such recorded data, the head part of the program of the aspect ratio=16:9 is converted from 4:3 to 16:9. This conversion is made according to the flowchart of FIG. 11. That is, when the aspect ratio of a given portion in video data is changed to the designated aspect ratio, the video data of the desired program can be obtained to have the aspect ratio=16:9.

As another method of allowing conversion from data of the DVD-VR standard that has different aspect ratios into that of the DVD-Video standard, a method of fixing the aspect ratio of the data to be converted from the DVD-VR standard is available. Such a method can be implemented by executing conversion according to the flowchart of FIG. 11 for VOBUs to be converted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video data conversion apparatus comprising:
a conversion unit configured to convert first digital video data that complies with MPEG and includes first aspect data with a first aspect ratio and second aspect data with a second aspect ratio, different from the first aspect ratio, into second digital video data having only the first aspect ratio by changing the second aspect data with the second aspect ratio into the first aspect data with the first aspect ratio without first converting the first digital video data into analog data; and
an output unit configured to output the second digital video data converted by the conversion unit.

2. An apparatus according to claim 1, wherein the first digital video data complies with a DVD-VR standard and the second digital video data complies with the DVD-VR standard.

3. An apparatus according to claim 2, wherein the first digital video data and the second digital video data each contain video object data obtained by encoding video and audio data, and management data, corresponding to the video object data, which is used to manage the video object data,
wherein the video object data contains a plurality of video object unit data, each video object unit data contains sequence header data, the sequence header data contains said first and second aspect data that designates said first and second aspect ratios respectively, and
wherein the conversion unit converts a first group of video object unit data having the second aspect data into a second group of video object unit data having the first aspect data by rewriting the second aspect data as said first aspect data.

4. An apparatus according to claim 3, wherein each second aspect data of the second digital video data is the same.

5. An apparatus according to claim 3, wherein the video object unit data contains sequence display extension data, the sequence display extension data contains display horizontal size data and display vertical size data, and
the conversion unit converts the first group of video object unit data having the second aspect data into the second group of video object unit data having the first aspect data by rewriting the display horizontal size data and the display vertical size data.

6. An apparatus according to claim 1, wherein the conversion unit converts the second digital video data having the first aspect data into third digital video data complying with a DVD-Video standard.

7. An apparatus according to claim 6, wherein the first digital video data and the second digital video data each contain video object data obtained by encoding video and audio data, and management data, corresponding to the video object data, which is used to manage the video object data,
wherein the video object data contains a plurality of video object unit data, each video object unit data contains sequence header data, the sequence header data contains said first and second aspect data that designates said first and second aspect ratios respectively, and
wherein the conversion unit converts a first group of video object unit data having the second aspect data into a second group of video object unit data having the first aspect data by rewriting the second aspect data as said first aspect data.

8. An apparatus according to claim 7, wherein each aspect data of the second digital video data is the same.

9. An apparatus according to claim 7, wherein the video object unit data contains sequence display extension data, the sequence display extension data contains display horizontal size data and display vertical size data, and
the conversion unit converts the first group of video object data unit data having the second aspect data into the second group of video object unit data having the first aspect data by rewriting the display horizontal size data and the display vertical size data.

10. A video data conversion method comprising:
converting first digital video data that complies with an MPEG standard and includes first aspect data with a first aspect ratio and second aspect data with a second aspect ratio, different from the first aspect ratio, into second digital video data having only the first aspect data by changing the second aspect data into the first aspect data without converting the first digital video data into analog data.

11. A method according to claim 10, wherein the first digital video data complies with a DVD-VR standard and the second digital video data complies with the DVD-VR standard.

12. A method according to claim 11, wherein the first digital video data and the second digital video data each contain video object data obtained by encoding video and audio data, and management data, corresponding to the video object data, which is used to manage the video object data, and
wherein the video object data contains a plurality of video object unit data, each video object unit data contains sequence header data, the sequence header data contains aspect data that designates an aspect ratio, the method further comprising:
converting a first group of video object data unit data having the second aspect data into a second group of video object unit data having the first aspect data by rewriting the second aspect data as the first aspect data.

13. A method according to claim 12, wherein each aspect data of the second digital video data is the same.

14. A method according to claim 12, wherein the video object unit data contains sequence display extension data, and the sequence display extension data contains display horizontal size data and display vertical size data, the method further comprising:
converting the first group of video object unit data having the second aspect data into the second group of video object unit data having the first aspect data by rewriting the display horizontal size data and the display vertical size data.

15. A method according to claim 10, further comprising converting the second digital video data having the first aspect data into third digital video data complying with a DVD-Video standard.

16. A method according to claim 15, wherein the first digital video data and the second digital video data each contain video object data obtained by encoding video and audio data, and management data, corresponding to the video object data, which is used to manage the video object data, and
wherein the video object data contains a plurality of video object unit data, each video object unit data contains sequence header data, the sequence header data contains aspect data that designates an aspect ratio, the method further comprising:
converting a first group of video object data unit data having the second aspect data into a second group of video object unit data having the first aspect data by rewriting the second aspect data as the first aspect data.

17. A method according to claim 16, wherein each second aspect data of the second digital video data is the same.

18. A method according to claim 16, wherein the video object unit data contains sequence display extension data, and the sequence display extension data contains display horizontal size data and display vertical size data, the method further comprising:
converting the first group of video object data unit data having the second aspect data into the second group of video object unit data having the first aspect data by rewriting the display horizontal size data and the display vertical size data.

19. A method according to claim 10, further comprising receiving a designation of a desired aspect ratio, wherein the desired aspect ratio corresponds to the first aspect ratio.

20. A video data conversion apparatus comprising:
a conversion unit configured to convert first video data which complies with a MPEG standard and has a plurality of different aspect ratios defined therein into second video data which complies with said MPEG standard and has a single aspect ratio defined therein by directly writing data corresponding to said plurality of aspect ratios within said first video data as a single aspect ratio to form said second video data without first converting said first video data into analog data; and
output unit configured to output the second video data converted by the conversion unit.

21. An apparatus according to claim 20, wherein said MPEG standard for both the first and second digital video data comprises the DVD-VR standard.

22. An apparatus according to claim 21, wherein the first digital video data and the second digital video data each contain video object data obtained by encoding video and audio data, and management data, corresponding to the video object data, which is used to manage the video object data,
wherein the video object data contains a plurality of video object unit data, each video object unit data contains sequence header data, the sequence header data contains first and second aspect data that designates said plurality of different aspect ratios and said single aspect ratio respectively, and
wherein the conversion unit converts a first group of video object unit data having the second aspect data into a second group of video object unit data having the first aspect data by rewriting the second aspect data as said first aspect data so that each second aspect data in the second group designates said single aspect ratio so as to form said second video data.

23. An apparatus according to claim 22, wherein the video object unit data contains sequence display extension data, the sequence display extension data contains display horizontal size data and display vertical size data, and
the conversion unit converts the first group of video object unit data having the second aspect data into the second group of video object unit data having the first aspect data by rewriting the display horizontal size data and the display vertical size data.

24. An apparatus according to claim 20, wherein subsequent to conversion of said first digital video data into said second digital video data, the conversion unit further converts the second digital video data having the single aspect ratio into third digital video data complying with a MPEG DVD-Video standard.

25. An apparatus according to claim 24, wherein the first digital video data and the second digital video data each contain video object data obtained by encoding video and audio data, and management data, corresponding to the video object data, which is used to manage the video object data,
wherein the video object data contains a plurality of video object unit data, each video object unit data contains sequence header data, the sequence header data contains first and second aspect data that designates said plurality of different aspect ratios and said single aspect ratio respectively, and
wherein the conversion unit converts a first group of video object unit data having the second aspect data into a second group of video object unit data having the first aspect data by rewriting the second aspect data as said first aspect data so that each second aspect data in the second group designates said single aspect ratio so as to form said second video data.

26. An apparatus according to claim 24, wherein the video object unit data contains sequence display extension data, the sequence display extension data contains display horizontal size data and display vertical size data, and
the conversion unit converts the first group of video object unit data having the second aspect data into the second group of video object unit data having the first aspect data by rewriting the display horizontal size data and the display vertical size data.

27. An apparatus according to claim 24, wherein subsequent to conversion of said first digital video data into said second digital video data, the conversion unit further converts the second digital video data having the single aspect ratio into third digital video data complying with a MPEG DVD-Video standard.

28. A method of video data conversion comprising the steps of:
converting first video data which complies with a MPEG standard and has a plurality of different aspect ratios defined therein into second video data which complies with said MPEG standard and has a single aspect ratio defined therein by directly writing data corresponding to said plurality of aspect ratios within said first video data as a single aspect ratio to form said second video data without first converting said first video data into analog data; and
outputting the second video data.

29. The method apparatus according to claim 28, wherein said MPEG standard for both the first and second digital video data comprises the DVD-VR standard.

30. An apparatus according to claim 29, wherein the first digital video data and the second digital video data each contain video object data obtained by encoding video and audio data, and management data, corresponding to the video object data, which is used to manage the video object data,
wherein the video object data contains a plurality of video object unit data, each video object unit data contains sequence header data, the sequence header data contains first and second aspect data that designates said plurality of different aspect ratios and said single aspect ratio respectively, and
wherein said converting step converts a first group of video object unit data having the second aspect data into a second group of video object unit data having the first aspect data by rewriting the second aspect data as said first aspect data so that each second aspect data in the second group designates said single aspect ratio so as to form said second video data.

31. An apparatus according to claim 30, wherein the video object unit data contains sequence display extension data, the sequence display extension data contains display horizontal size data and display vertical size data, and
said converting step further includes converting the first group of video object unit data having the second aspect data into the second group of video object unit data having the first aspect data by rewriting the display horizontal size data and the display vertical size data.

32. An apparatus according to claim 31, wherein subsequent to converting said first digital video data into said second digital video data, the method further comprises the step of converting the second digital video data having the single aspect ratio into third digital video data complying with a MPEG DVD-Video standard.

33. An apparatus according to claim 28, wherein subsequent to converting said first digital video data into said second digital video data, the method further comprises the step of converting the second digital video data having the single aspect ratio into third digital video data complying with a MPEG DVD-Video standard.
